(19) United States
(12) Patent Application Publication
(10) Pub. No.: US 2014/0080347 A1
(43) Pub. Date: Mar. 20, 2014

(54) DIRECT PLUG ELEMENT, PARTICULARLY FOR VEHICLE CONTROL DEVICES

(71) Applicants: Eckhardt Philipp, Schwieberdingen (DE); Werner Hofmeister, Muehlacker (DE)

(72) Inventors: Eckhardt Philipp, Schwieberdingen (DE); Werner Hofmeister, Muehlacker (DE)

(73) Assignee: Shiloh Industries, Inc, Valley City, OH (US)

(21) Appl. No.: 14/006,574

(22) PCT Filed: Feb. 23, 2012
(86) PCT No.: PCT/EP12/53038

§ 371 Date: Dec. 5, 2013

(30) Foreign Application Priority Data
Mar. 21, 2011 (DE) 10 2011 005 858.3

(51) Int. Cl. H01R 13/639

(52) U.S. Cl. CPC H01R 13/639
USPC 439/347

(57) ABSTRACT

A direct plug element is described, including a housing, a two-part contact carrier having a first contact carrier part and a second contact carrier part, at least one of the contact carriers having a direct contact, the two contact carrier parts being situated disengaged in the housing but secure from loss, and a slider in the sealed region, which is able to be brought into contact with the contact carrier parts, in the contact state, due to the slide, a first prestressing force onto the first contact carrier part being present in the contact state in a first direction, and a prestressing force onto the second contact carrier part in a second direction being present, essentially counter to the first direction.

### FIELD OF THE INVENTION

The present invention relates to a direct plug element for an improved multiple direct contacting of electrical components, such as circuit boards, the direct plug element being used particularly in control units of vehicles.

### BACKGROUND INFORMATION

The use of direct plug contacts in which a direct plug element is plugged in directly on a circuit board has been increasing most recently. In a large number of contact areas on the circuit board, the contact areas are situated in a row close to an edge of the circuit board, in this context. If many contact areas are required, there comes about a corresponding length on the circuit board as well as complicated wiring on the circuit board. Furthermore, when using direct plug elements in vehicles, for instance, for contacting control units, the problem arises that the plug connections are exposed to shaking motions. Moreover, contacts may wear, and for this reason they are not electrically stable. Furthermore, one should note that a mounting force for mounting into the direct plug element on the control unit must not be too high, in order to prevent damage on the control unit and/or the direct plug element.

### SUMMARY

By contrast, the direct plug element according to the present invention has the advantage that, on the one hand, mounting using a reduced mounting force is possible, and on the other hand, a secure connection is possible between the direct plug element and a carrier plate such as a circuit board of a control unit. The reduced mounting force may be set in such a way, in this instance, that a nearly force-free mounting may be accomplished. The direct plug element, according to the present invention, furthermore has a simple and cost-effective design, and requires only very slight installation space. This is achieved, according to the present invention, in that the direct plug element includes a housing and a two-part contact carrier. The contact carrier has a first and a second contact carrier part, at least one of the contact carriers having a contact element. The contact element is provided for direct contact to a contact region, such as a pad, on a carrier plate of a control unit, for example. The two contact carrier parts mentioned are situated disengaged, but secure from loss, in the housing of the direct plug element. Moreover, a slider is provided, which is able to be brought into contact with the contact carrier parts. In the mounted state, the slider applies prestressing to the two contact carrier parts in opposite directions to each other, so that the contact carrier parts are no longer situated loose in the housing. Consequently, because of the disengaged carrier parts in the housing, simple mounting is possible, without great force expenditure. The disengaged carrier parts are simply pushed to the side when a circuit board, or the like, is mounted. According to the present invention, the contact carrier parts are situated disengaged in the housing in such a way that they cannot fall out by themselves, which may be made possible, for example, using projections or the like on the housing. Furthermore, the two contact carrier parts are situated in the housing disengaged only to a certain extent, so that the contact carrier parts always demonstrate a predetermined alignment, even in the disengaged state, and their position may only be changed to a predetermined, specified extent. After the direct plug connection has been established, according to the present invention, the position of a slider is changed by pushing or pulling in such a way that the slider comes into contact with the contact carrier parts and exerts the prestressing on the contact carrier parts. This achieves a secure contact between the direct plug element and the contacts areas on the carrier plate.

Between the two contact carrier parts, a widening slit is preferably provided, especially a conically widening slit.

This already enables a slight prefixing of a carrier plate pushed into the slit. In a particularly preferred manner, the slider includes a large number of nose-like projections, which may be brought into contact with the contact carrier parts, so as to prestress the latter. For simpler movability of the slider, the nose-like projections preferably have a leading slant.

In a particularly preferred manner, the slider includes a first arm and a second arm which are connected to each other in an end region, the nose-like projections being situated on areas of the arms facing inwards. Particularly preferred in this instance, the nose-like projections are provided at the same positions on the two arms in the direction of motion of the slider, so as to clamp in the two disengaged contact carrier parts by the nose-like projections between themselves at a predetermined prestressing force. In order further to reduce the unintended detaching of the direct plug element, the direct plug element preferably includes a latching device in order to latch the slider on the housing. The latching device is preferably a clipping connection.

In order to achieve as good as possible a prestressing force on the two contact carrier parts, even at higher manufacturing tolerances, spring elements are additionally situated on the two contact carrier parts, the spring elements being provided between the contact carrier part and the slider. It may thereby be achieved by a motion of the slider that the nose-like projections of the slider run onto the spring elements, and the prestressing force is transmitted to the contact carrier parts via the spring elements. The spring elements are preferably made of sheet metal, particularly of spring steel sheet.

The overall play of the contact carrier parts, that are situated disengaged in the housing, in all directions is particularly preferably at most as great as the maximum thickness of a contact carrier part or a carrier plate in a direction perpendicular to the push-in direction of the carrier plate.

Further preferred, the slider is situated so that, by a motion of the slider, at least one contact carrier part, preferably both contact carrier parts, are displaceable. Furthermore, a modular design is possible, for instance, one contact carrier part is bigger than the other contact carrier part.

Moreover, the present invention relates to an electrical system, including a direct plug element, according to the present invention, and a carrier plate, a circuit board, in particular, having exposed contact areas. In the mounted state, the exposed contact areas are situated between the contact carrier parts, in this instance, and directly come into contact with direct contacts of the contact carrier parts. This ensures the electrical contacting of the carrier plate.

### BRIEF DESCRIPTION OF THE DRAWINGS

FIG. 1 shows a schematic top view onto a direct plug element, which is plugged onto a control unit for a vehicle.

FIG. 2 shows a schematic sectional view along line II-II of FIG. 1, having the circuit board mounted.

FIG. 3 shows a schematic sectional view along line II-II of FIG. 1, having the circuit board mounted.

FIG. 4 shows a schematic sectional view of the direct plug element of FIG. 1, which indicates the mounting process of the circuit board.

### DETAILED DESCRIPTION

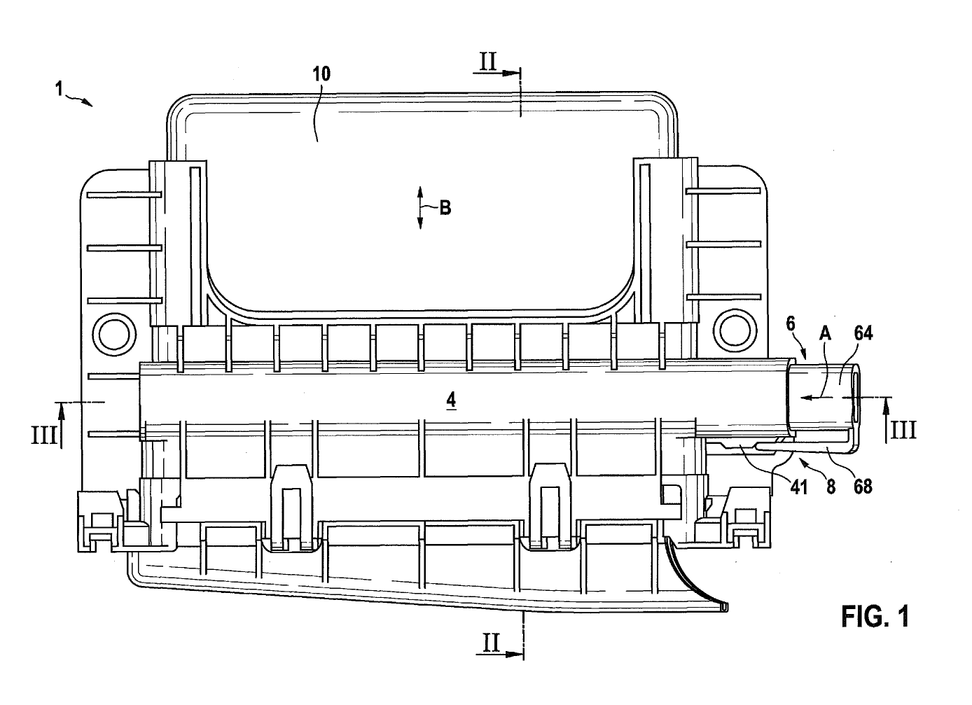

An electrical system 1 and a direct plug element 3 according to an exemplary embodiment of the present invention is described in detail below with reference to FIGS. 1 through 4.

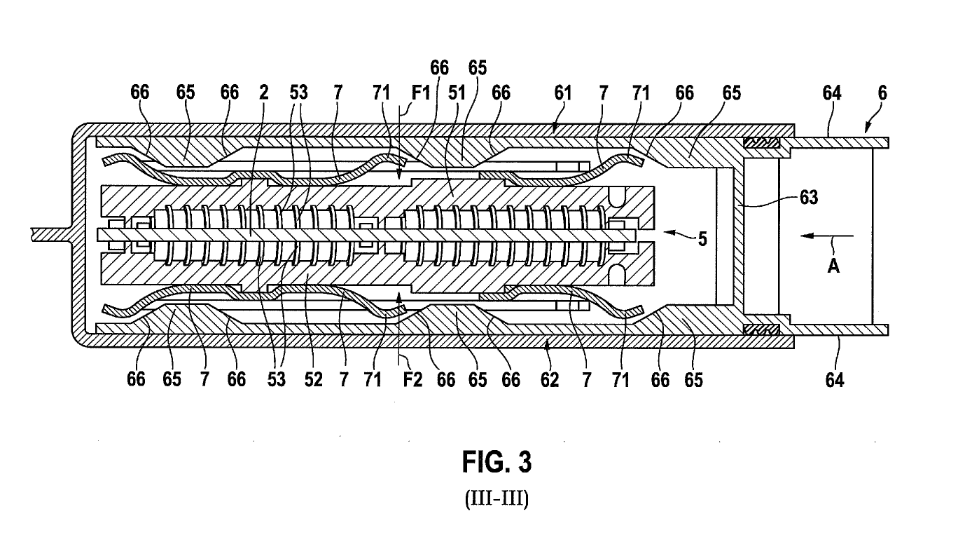

The direct plug element 3 according to the present invention includes a housing, preferably made of plastic, and a two-part contact carrier 5 situated in housing 4. Contact carrier 5 includes a first contact carrier part 51 and a second contact carrier part 52. Contact carrier parts 51, 52 are situated disengaged in the housing. Projections in the housing, that are not shown, prevent disengaged contact carrier parts 51, 52 from falling out of housing 4, in this context. The play of contact carrier parts 51, 52 in housing 4 is such, in this instance, that contact carrier parts 51, 52 are not able to execute any basic directional changes, such as rotations by 360° in the horizontal and vertical direction, but maintain their principal direction. On contact carrier parts 51, 52, in each case, a large number of direct contacts 53 are situated, which are able to produce direct electrical contact with contact areas 20 on a carrier plate 2, for instance, of a circuit board. Direct plug element 3 also includes a slider 6. Slider 6 is able to be operated by hand and has a first arm 61 and a second arm 62 (cf. FIG. 3). The two arms 61, 62 are connected to each other via a connecting area 63 at one end of slider 6. Furthermore, outside of housing 4, handling surfaces 64 are provided, to enable manual operation of slider 6. Slider 6 also includes a plurality of nose-like projections 65, which are situated on inwards-directed regions of arms 61, 62. At each nose-like projection 65, at least one leading slant 66 is provided.

As indicated in FIGS. 1 and 3 by arrow A, slide 6 may be manually displaced transversely to a contact direction B.

Direct plug element 3 shown in this exemplary embodiment is used to produce a direct plug connection to a control unit 10 of a vehicle.

Furthermore, a plurality of spring elements 7, made of an elastic spring steel sheet, is fastened on contact carrier 5. Spring elements 7 each have free end regions 71, developed to be curved, which come into contact with leading slants 66 of nose-like projections 65 on slide 6, during the pushing in of the slide in direction A. Because of this, after the pushing in of slide 6 in direction A, a first prestressing force F1 is exerted on first contact carrier part 51, and a second prestressing force F2, which is directed counter to prestressing force F1, is exerted on second contact carrier part 52. In this context, FIG. 3 shows the state in which carrier plate 2 has already been pushed into contact carrier 5, but slider 6 has not yet been moved in the direction of arrow A.

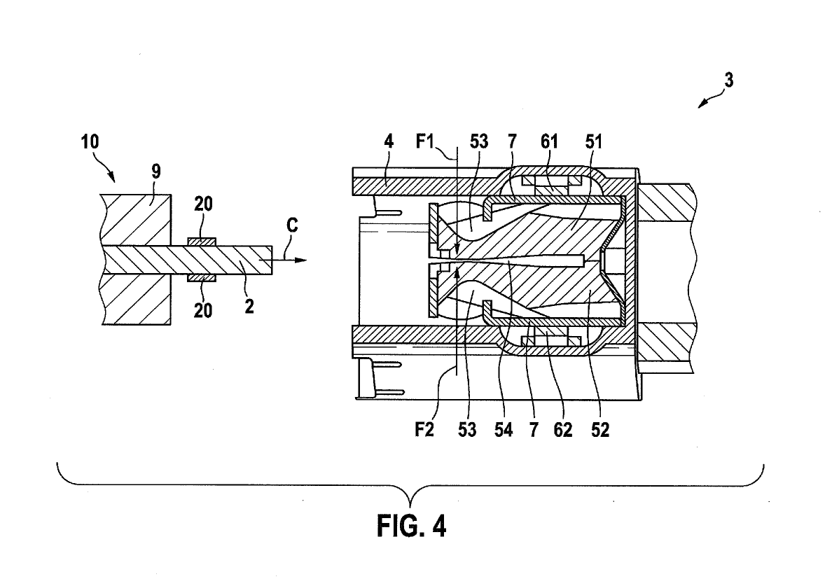

As shown in FIG. 4, in the state in which carrier plate 2 has not yet been introduced into direct plug element 3, a slit 54 is formed between the first and the second contact carrier part 51, 52, which widens conically in introduction direction C. Because of the conically widening slit it is achieved that when, as indicated in FIG. 4, carrier plate 2 is introduced in introduction direction C between the two contact carrier parts 51, 52, contact carrier parts 51, 52 are lightly pressed against the inner wall of housing 4, so that prefixing of the circuit board in direct plug element 3 is made possible. Subsequently, slider 6 is pushed in, so that a specified prestressing is exerted via nose-like projections 65 and spring elements 7 on contact carrier parts 51, 52.

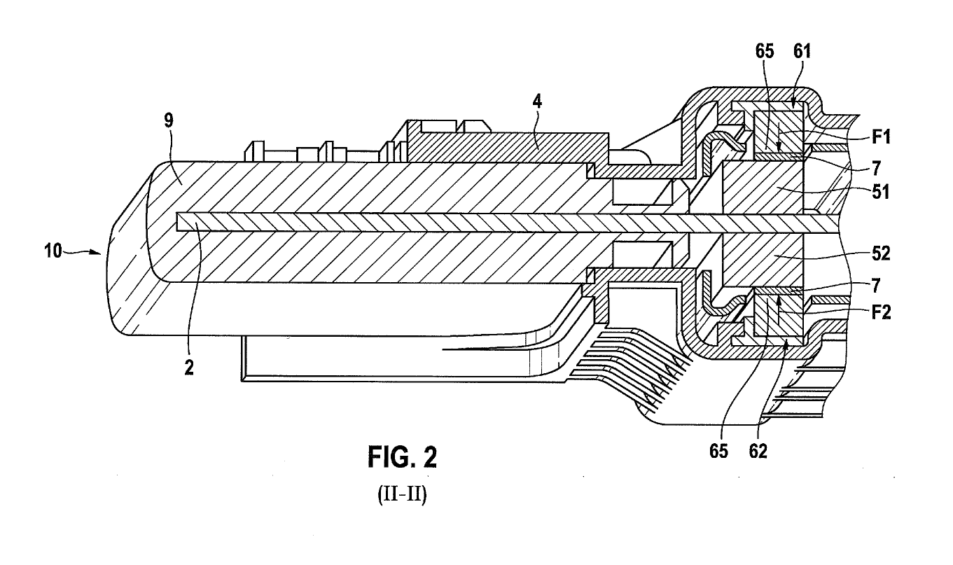

Consequently, in the pushed-in state of carrier plate 2, direct contacts 53 rest with prestressing on contact areas 20 of the carrier plate, so that a secure electrical contact exists. FIG. 2 shows the pushed-in state of slider 6. In this context, nose-like projections 65 press against contact carrier parts 51, 52 via spring elements 7, so that carrier plate 2 is clamped between contact carrier parts 51, 52.

Upon use in a vehicle, in order to prevent the plug connection from coming apart again because of shaking motions or the like, a latching device 8 is also provided between slider 6 and housing 4. As may be seen in FIG. 1, latching device 8 includes a projection 41 formed as one piece on housing 4 and a latching bracket 68 situated on slider 6, so that after the pushing in of slider 6, the latching bracket engages behind projection 41, and the pushed-in position of slider 6 is therefore latched. This is able securely to prevent an undesired detaching of slider 6, and, with that, the detaching of direct plug element 3 from carrier plate 2.

Consequently, according to the present invention, first, carrier plate 2 is pushed in between contact carrier parts 51, 52, that are located in a disengaged manner in housing 4, using only a slight expenditure of force. A first prefixing of the carrier plate is made possible by the slit between the two contact carrier parts 51, 52 that widens conically. Subsequently, slider 6 is pushed in, in the direction of arrow A, so that prestressing F1, F2 is exerted upon contact carrier parts 51, 52. At the same time, in this context, the securing of slider 6 by latching device 8 also takes place. To detach the direct plug connection, first latching device 8 is detached and slider 6 is pulled out again partially from housing 4. Because of this, the prestressing force on contact carrier parts 51, 52 drops out, so that carrier plate 2 is able to be pulled out again from direct plug element 3 without a great expenditure of force.

It should further be noted that, between slider 6 and housing 4, a separate seal may also be provided, to avoid the penetration of moisture, etc., from the outside into the plug connection.

1.-10. (canceled)

11. A direct plug element, comprising:
a housing;
a two-part contact carrier, including a first contact carrier part and a second contact carrier part, wherein:
at least one of the first contact carrier part and the second contact carrier part includes a direct contact, and
the first contact carrier part and the second contact carrier part are situated in the housing in a disengaged manner but secure from loss; and
a slider that is able to be brought into contact with the two-part contact carrier, in a contact state, by the slider, wherein:
a first prestressing force onto the first contact carrier part in a first direction is present, and
a second prestressing force onto the second contact carrier part in a second direction, counter to the first direction, is present.

12. The direct plug element as recited in claim 11, wherein between the first contact carrier part and the second contact carrier part a widening slit is provided.

13. The direct plug element as recited in claim 12, wherein the widening slit is a conically widening slit.

14. The direct plug element as recited in claim 11, wherein:
the slider includes a plurality of nose-like projections that are able to be brought into contact with at least one of the first contact carrier part and the second contact carrier part, in order to prestress the first contact carrier part and the second contact carrier part.

15. The direct plug element as recited in claim 14, further comprising:
leading slants developed on the nose-like projections.

16. The direct plug element as recited in claim 14, wherein:
the slider includes a first arm and a second arm that are connected to each other by an end region, and
the nose-like projections are situated on areas of the first arm and the second arm facing inwards.

17. The direct plug element as recited in claim 11, further comprising:
a latching device in order to latch the slider in the contact state to the housing.

18. The direct plug element as recited in claim 11, further comprising:
a plurality of spring elements situated on the first contact carrier part and the second contact carrier part for a force transmission in connection with the slider.

19. The direct plug element as recited in claim 18, wherein the spring elements are produced from sheet metal.

20. The direct plug element as recited in claim 19, wherein the sheet metal includes a spring steel sheet.

21. An electrical system, comprising:
a direct plug element including:
a housing,
a two-part contact carrier, including a first contact carrier part and a second contact carrier part, wherein:
at least one of the first contact carrier part and the second contact carrier part includes a direct contact, and
the first contact carrier part and the second contact carrier part are situated in the housing in a disengaged manner but secure from loss, and
a slider that is able to be brought into contact with the two-part contact carrier, in a contact state, by the slider, wherein:
a first prestressing force onto the first contact carrier part in a first direction is present, and
a second prestressing force onto the second contact carrier part in a second direction, counter to the first direction, is present; and
a carrier plate including contact areas exposed on the carrier plate, the exposed contact areas being situated between the first contact carrier part and the second contact carrier part in the contact state.

22. The system as recited in claim 21, wherein the carrier plate is a part of a control unit for a vehicle.
